(19) United States
(12) Patent Application Publication
(10) Pub. No.: US 2007/0261231 A1
(43) Pub. Date: Nov. 15, 2007

(54) Methods of manufacturing and assembling electromagnetic assemblies and core segments that form the same

(75) Inventors: Lowell M. Bosley, Butler, PA (US); Joseph F. Huth III, Butler, PA (US)

Correspondence Address: KIRKPATRICK & LOCKHART PRESTON GATES ELLIS LLP, 535 SMITHFIELD STREET, PITTSBURGH, PA, 15222, US

(73) Assignee: Spang & Company

(21) Appl. No.: 11/430,409

(22) Filed: May 9, 2006

(51) Int. Cl. H01F 41/02; G11B 5/127; H01F 7/06

(52) U.S. Cl. 29/604; 29/607

(57) ABSTRACT

Electromagnetic assemblies, core segments that form the same, and their methods of manufacture. The segments have an interlocking engagement, whereby a variety of assemblies can be produced from a very small number of similar or complementary segments in a manner that provides excellent mechanical stability. The articles and methods of formation offer design flexibility and provide for a large variety of patterns from a small number of primary shapes, provide an economical manufacturing method for large transformer and inductor cores, and improve uniformity of magnetic properties of the assemblies when compared to conventional practices.

### CROSS-REFERENCE TO RELATED APPLICATIONS

This patent application is related to the U.S. Patent Application entitled “Electromagnetic Assemblies, Core Segments that Form the Same, and Their Methods of Manufacture” Attorney Docket No. 060206, filed concurrently herewith, the contents of which are incorporated by reference herein in their entirety.

### FIELD

The invention relates to electromagnetic assemblies, core segments that form the same, and their methods of manufacture.

### BACKGROUND

Soft magnetic cores made from ceramic materials such as Mn—Zn ferrite, Ni—Zn ferrite, and other soft magnetic ferrite compositions, and from powdered metallic alloys such as Fe, Fe—Al—Si, Fe—Co, Fe—Co—V, Fe—Mn, Fe—P, Fe—Si, Ni—Fe, Ni—Fe—Mo, and other soft magnetic alloys, have been commercially available for decades. More recently, amorphous and nanocrystalline soft magnetic alloys made by a variety of rapid solidification techniques and reduced to powder form by atomization or comminution are becoming commercially available. Single-piece cores such as ring cores (toroids) are available in sizes up to about 150 mm diameter. Sizes beyond 150 mm diameter are uneconomical to produce, requiring very large high-tonnage presses to consolidate the ceramic or metal powders into the desired shapes. Commercially available presses capable of more than 1000 tons of compaction force are uncommon and expensive to purchase and operate. Typical pressing pressures required to consolidate many soft magnetic powders, such as Fe—Si and Fe—Si—Al powders which have very low ductility, can reach 150 tons per square inch (tsi) in order to achieve high target densities. High densities are important in fully developing optimum magnetic properties for any given material, and reductions in pressing pressure lead to inferior core performance.

For example, a 1000-ton press used to compact a powder requiring 150 tsi pressure will be limited to a pressing area of 6.67 square inches (1000 tons divided by 150 tsi). Pressing areas greater than 6.67 square inches will result in lower pressures and degraded core performance. For example, one commercially acceptable soft magnetic core formed with 150 tsi pressing area is a toroid of approximately 3.36″ outside diameter (OD) and 1.68″ inside diameter (ID), a 2:1 ratio of OD to ID being a common proportion for toroids. A typical powder compacting die to produce this part will consist of a cylindrical die cavity; a center core rod (a solid cylinder) positioned parallel to the axis of the cylindrical opening, and in the center of the opening thus creating an annular cavity; a bottom punch with an annular cross section that closely fits the die cavity; and a top punch with the same annular cross section as the bottom punch. These four pieces of tooling are held in proper alignment by attachment to a common structure, known as a tool set, and the tool set is provided with external attachment points to fit into an appropriate compacting press. The tool set allows the top and bottom punches to move longitudinally within the die cavity and also allows the top punch to travel vertically out of engagement with the die so the empty cavity is exposed and powder can be introduced into the cavity for each pressing cycle. Once filled with powder, the top punch re-enters the annular cavity and compresses the powder into a solid form. Therefore, to determine the maximum core size that can be produced on a press, one divides the maximum force the press can generate by the cross section of the annular face of the top punch.

In addition to toroidal shapes, mated pairs of coresare commonly used, with an E-shaped configuration being typical. Other cores used in mated pairs can be shaped to correspond to the letters U, I and C. Unlike toroids which have a closed magnetic pathway, E, U, I and C cores are open-ended and as such usually require mating with another core, open end-to-open end, to create a closed magnetic pathway. E-to-E, E-to-I, U-to-U, U-to-I, C-to-C and C-to-I core pairings are also common. Using a 1000-ton press and 150 tsi pressure limit, a common configuration of an E-core with typical proportions would be limited to approximate dimensions of 4.75 inches in length and 2.37 inches in height, or about 6.67 square inches.

In yet another example, an open-ended E, U, I or C core used by itself as a magnetic device would also be limited to the same dimensional limits as the mated pairs described above, since each core half, whether used as a mated pair or not, is pressed individually.

In a further example, reducing the pressing pressure to 40 tsi, a typical pressing pressure for more ductile materials such as powdered iron, and continuing to use a 1000-ton press, provides a maximum single piece toroid size of about 6.50 inches OD and 3.25 inches ID.

More restrictive limitations on maximum core sizes are imposed if more common and economical presses are employed, such as those presses with capacities of only 400 to 750 tons of pressing force.

Circuit designers thus have limits on the size of available cores made from these materials. For comparative illustration purposes, large magnetic cores of sizes beyond those examples provided herein are commercially available made from alloys such as Fe, Fe—Si, Fe—Co, Fe—Co—V, Fe—Mn, Fe—P, Ni—Fe, and Ni—Fe—Mo that have been rolled into thin ribbons. These cores are known as tape wound cores, and are created by building up multiple wraps of the magnetic ribbon on a pre-form, or mandrel, of the desired shape. Most common tape wound cores are in the form of a toroid, an oval toroid or rectangle, or several toroids or ovals which are assembled to create an E-core shape. These cores are labor intensive to manufacture in large sizes and have other important drawbacks that limit their use. They can be limited to use at lower frequencies, typically less than 100 kHz, due to high eddy current losses associated with and proportional to the ribbon thickness. To reduce eddy current losses, ribbon thickness can be reduced, but the practical lower limit is about 0.0005 inches. Thinner gages, down to 0.0000125 inches, are commercially available but are extremely expensive, and creating large cores from this delicate material is impractical. Fabricating long continuous lengths of ribbon at very thin gages that is also wide enough to create the desired final dimensions of the magnetic core is difficult and expensive. In addition, with each wrap of ribbon there is a laminar gap that cannot be reduced to zero; known in the trade as a “stacking factor.” A typical stacking factor for a core made from 0.0005″ thick ribbon is 60%. Accordingly, a core must be substantially larger than the arithmetic sum of the thicknesses of the wraps, leading magnetic cores that can be up to 50% larger for any given power output.

Tape wound cores are also limited to certain metal alloys whose ductility permits fabrication into ribbon form by rolling, or that can be cast to final gauge thickness directly. Ceramic magnetic materials cannot be formed into ribbons, and, thus, cannot be used in tape-wound configurations.

When the application requires cores larger than those commercially available, circuit designers have resorted to stacking smaller toroids, E, U, I or C cores together. This approach has limited benefit as the winding cross-section of the core, the area where the coil of wire resides, is not increased by stacking and therefore limits the amount of extra power such a stack can produce. For example, a toroid has a winding area limited by the size of the hole in the core. Stacking multiple toroids one upon another will geometrically increase the cross section of the magnetic material, which is capable of delivering more power, but the diameter of the hole remains the same. Because power (P) equals voltage (V) multiplied by current (I), and because any given circuit is confined to run at its specific designed voltage level, more power can only be generated by increasing the current in the windings. Therefore, the current in the windings is directly proportional to the cross section of the core for any desired output. Higher current densities, however, require heavier gauge wire to prevent overheating and excessive electromagnetic losses, and the hole in the stack of toroids will limit the wire size and number of turns of wire that can be wound. Therefore, the practice of stacking cores is of limited value when constructing large power inductors.

Alternatively, simple square or rectangular blocks of the aforementioned materials can be stacked and bonded together to make larger core shapes. One example of such a practice is disclosed in International Publication WO 2005/041221 A1. This approach limits the assemblies to rudimentary shapes and must rely on the skill of those assembling the pieces to achieve the necessary alignment of the segments. The uncured adhesive applied between segments can act as a lubricant, so clamping segments together for curing is a non-trivial task. Careful jigging or registration of the pieces is required until the adhesive cures to assure not only alignment of the segments, but that the gaps between segments are uniform and controlled. If the gaps between pieces are too large, the inductance of the assembly is reduced, and if the gap widths are too variable from assembly to assembly, the electrical properties will have excessive variation. This effect is described in Equation 1:
μₑμₒ/(1+(gaP/Iₑ)μₒ) Eq. 1
where μₒ is the permeability of the individual segments, Iₑ is the magnetic path length of the assembly, “gap” is the sum of the gap lengths between pieces, and μₑ is the effective permeability of the assembly. If the gap created by the adhesive (the glue line) varies excessively, the electrical properties of the assembled cores will be unacceptable. Depending on the permeability of the magnetic segments, the air gaps introduced by variations in the glue line thickness can have a large impact on the effective permeability of the final assembly. Using Equation 1, the change in effective permeability for a typical inductor material (60 permeability) and a typical transformer material (2500 permeability) are shown in FIGS. 1 and 2.

In inductor applications, low permeability material is required. Low permeability materials are created by taking the powder form of soft magnetic metal alloys and coating the particles with a non-magnetic coating. In effect, this creates a large number of very small air gaps between particles after the powder is compressed into a desired shape. Cores selected for inductor applications usually have a permeability of 300 or less. For example, many inductors use 60-perm material, and this material has its effective permeability reduced by nearly 8% if the sum total of all air gaps, created by the glue line thickness, around the magnetic path length is as little as 0.5 mm. Following the teachings of International Publication WO 2005/041221 A1 will naturally lead to the introduction of multiple air gaps. A review of commercially available inductor cores shows a guaranteed inductance value of, typically, +/−8% to +/−12% of nominal values. For example, Magnetics, a division of Spang & Company, Pittsburgh, Pa., discloses +/−8% tolerances for their molypermalloy (Fe—Ni—Mo) and High Flux (Fe—Ni) alloys, and +/−12% for their Kool Mu® Fe—Al—Si) 60-perm materials. These published tolerances cover normal processing variations such as (i) particle size distribution of the pre-compacted powder, (ii) thickness variations in the non-magnetic coating typically applied to these powders, (iii) variations in chemistry of the alloy during manufacture, and (iv) variations in powder fill during pressing operations. The introduction of yet another source of variation, namely variation in air gaps in the assembled structure, would result in a core that has too broad of a range of inductance values within a production lot, and from lot to lot, and would be non-competitive in the marketplace. Any process that increases the tolerance on the inductor core is undesirable for one or more reasons: 1) the inductance of a wound core is directly proportional to the square of the number of turns of wire (See, Eq. 2); 2) inductors are usually wound to very specific inductance values; and 3) it is uneconomical to customize the number of turns of wire on a core-by-core basis to adjust for inductance variations resulting from variable air gap dimensions. Along with avoiding the aforementioned process variations, it is important to fully develop the electromagnetic properties of each material, regardless of its composition or assembly techniques. FIGS. 3, 4, 5 and 6 show the deleterious effects of compacting powdered soft magnetic materials at reduced pressures. For illustration purposes, a typical sendust alloy (Fe—Al—Si composition) is used in these figures. Other magnetic materials used in inductor applications will show similar trends if they are compacted at pressures below that which optimizes their electromagnetic properties.

In transformer applications where high inductance is required, materials such as ferrite are chosen due to their relatively high permeability ranging from about 500 to about 20,000. The permeability of a material directly affects the inductance of a core assembly, as described in Equation 2, where L is the inductance of the core (in Henries), N is the number of turns of wire on the core, μₒ is the permeability of the material, Aₑ is the effective cross section of the core, and Iₑ is the effective magnetic flux path length in the core.
L=((0.4πN²μₒAₑ)/Iₑ)*10⁻⁸ Eq. 2
Unfortunately, cores made from high permeability materials suffer the largest drop in inductance with the introduction of air gaps, as shown in FIG. 2. Introducing air gaps into cores meant for transformer applications degrades their performance and the total air gap length should be kept to a minimum. Therefore the teachings of WO 2005/041221 A1 have not found practical application in transformer applications.

Japanese Publication No. 04-165607 is said to teach improved manufacturing efficiency by adhering segments together in overlapping layers to form larger, useful magnetic assemblies. The teachings of this reference are similar to WO 2005/041221 A1, and discuss how segments are used as building blocks. However, Japanese Publication No. 04-165607 teach only simple shapes that have no means of establishing registration between segments, and no means to control inductance of the final assembly. Air gaps created by glue lines that interrupt the magnetic path length are uncontrolled and will lead to an undesirably high degree of variation in inductance from assembly to assembly. Similar teachings are offered in Japanese Publication Nos. 61-071612 and 59-178716, where magnetic materials in strip form are laminated into larger assemblies.

Accordingly, continuous efforts are needed to develop electromagnetic assemblies and their related methods of manufacture to further advance the technology of high power inductor and transformer cores made from these assemblies.

### BRIEF SUMMARY

In one embodiment, a magnetic core segment is provided, comprising a first interlocking member configured to form an interlocking portion with a second interlocking member of a second magnetic core segment.

In another embodiment, a magnetic core assembly is provided, comprising a first segment and a second segment, at least a portion of the first segment configured to form an interlocking portion with at least a portion of the second segment.

In yet another embodiment, a stacked magnetic core assembly is provided, comprising first and second magnetic cores assemblies, the first and second magnetic core assemblies each further comprising an inter-layer interlocking member configured to form an inter-layer interlocking portion therebetween.

In another embodiment, a method of forming a magnetic core segment is provided, comprising forming a magnetic core segment comprising an interlocking member thereon, the interlocking member configured to form an interlocking portion with a second interlocking member of a second magnetic core segment.

In another embodiment, a method of forming a segmented magnetic core assembly is provided, comprising: contacting a first segment to a second segment, the first segment having an interlocking member configured to form an interlocking portion with a second interlocking member of the second magnetic core segment; and interlocking the first segment to the second segment to form the segmented magnetic core assembly.

In yet another embodiment, a method of forming a stacked magnetic core assembly is provided, comprising: placing a first magnetic core assembly over a second magnetic core assembly, the first and second magnetic core assemblies each comprising an inter-layer interlocking member configured to form an inter-layer interlocking portion therebetween.

In another embodiment, a method of forming a segmented magnetic core assembly is provided, comprising selecting individual interlocking segments based on a selected size and shape of the assembly.

It should be understood that this invention is not limited to the embodiments disclosed in this Summary, and it is intended to cover modifications that are within the spirit and scope of the invention, as defined by the claims.

### BRIEF DESCRIPTION OF THE DRAWINGS

The features and benefits presented in this invention are better understood through the detailed description of certain embodiments and the accompanying drawings, wherein:

FIG. 1 is a graph that illustrates the change in effective permeability with the change in the gap between segments, where the initial permeability of each segment is 60, and represents a typical material used in high power inductor applications;

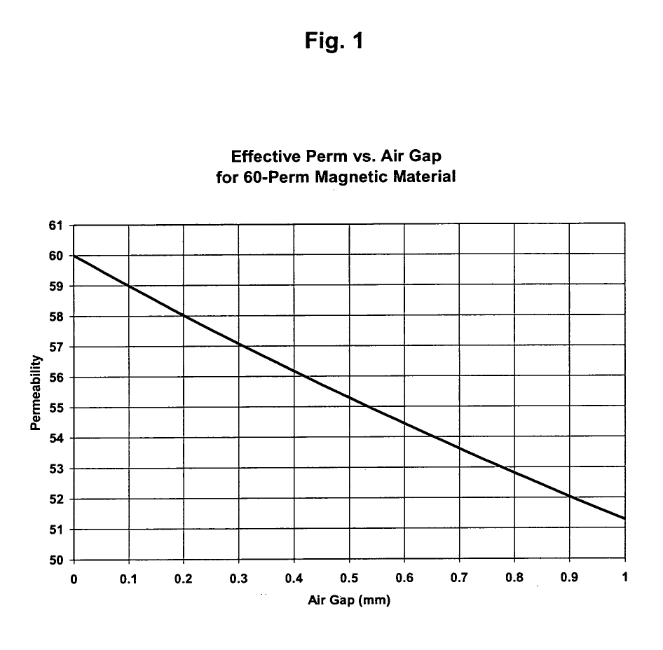

FIG. 2 is a graph that illustrates the change in effective permeability with the change in the gap between segments, where the initial permeability of each segment is 2500, and represents a typical material used in high power transformer applications;

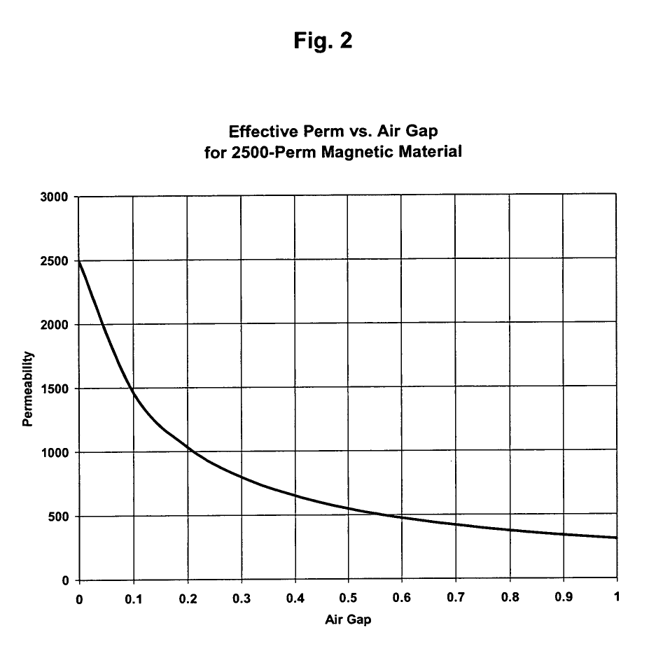

FIG. 3 illustrates the improvement in magnetic core loss achieved by pressing core segments to higher pressures;

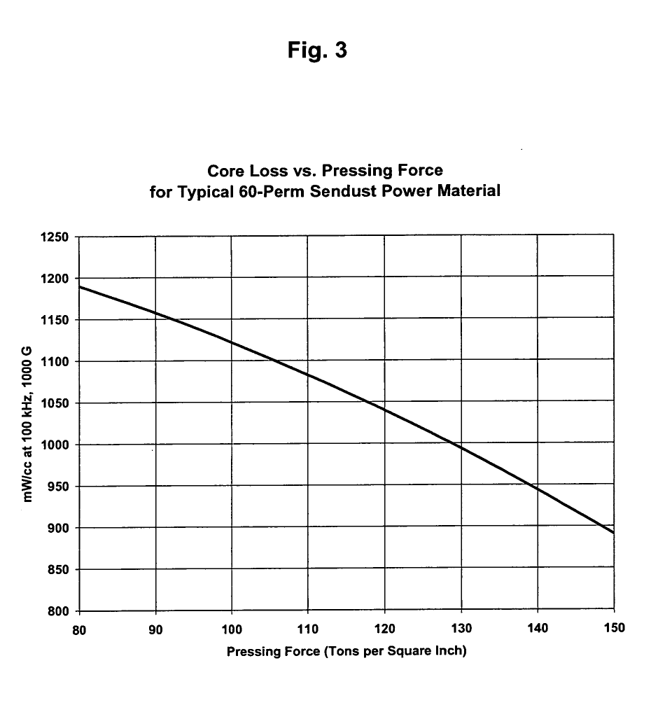

FIG. 4 illustrates the improvement in core strength with higher pressing force;

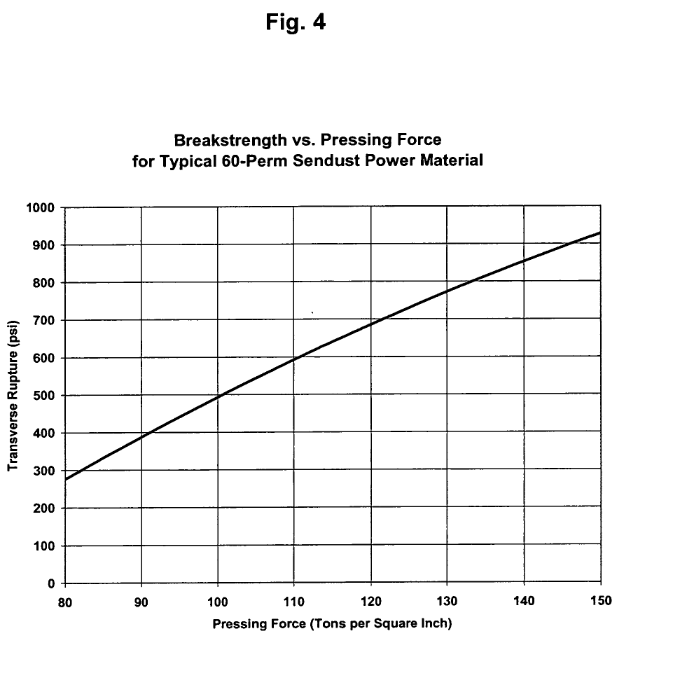

FIG. 5 illustrates the effect of pressing force on the final permeability of the core;

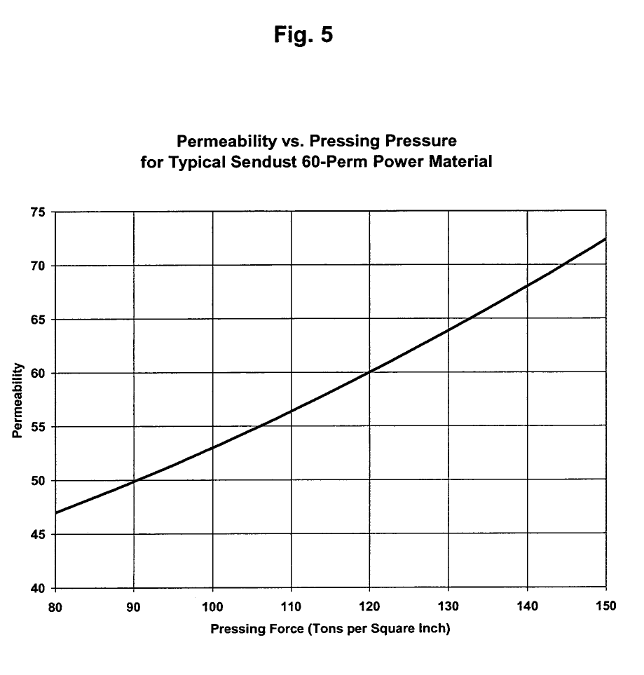

FIG. 6 illustrates the improvement in compacted core density with increased pressing force;

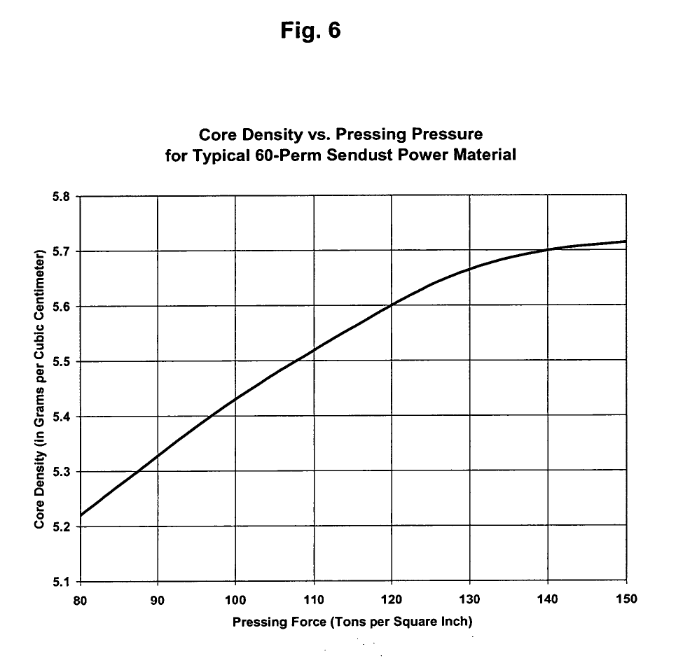

FIGS. 7-7E are plan views that illustrate embodiments of the invention, wherein interlocking segments using certain primary shapes form a wide variety of larger, more complex assemblies;

FIG. 8 is a perspective view that illustrates a powder compaction die that may be employed to form the segments shown in FIGS. 7-7E;

FIG. 9 is a perspective view that illustrates additional interlocking designs of the invention in the form of toroid assemblies;

FIGS. 10A-10C are plan views that illustrate adhesive bonding of segments while eliminating glue line thickness variations;

FIGS. 11A and 11B are perspective views that illustrates interlocking engagement between segments that can be applied in both radial and circumferential symmetries;

FIGS. 12A and 12B are perspective views that illustrate alternative embodiments of the invention with enhanced segment interlocking engagement;

FIGS. 13A-13C are plan views that illustrate various assembly configurations, such as oval and triangular shaped toroids, and alternate interlocking geometries;

FIGS. 14A-14C are perspective views that illustrate one method of inserting a pre-wound bobbin onto partially-formed assemblies of the invention;

FIGS. 15A and 15B are perspective views that illustrate alternative embodiments of the invention that encompass layer-to-layer interlocking assemblies;

FIG. 16 illustrates a series of perspective views of large E-cores having round center legs that employ embodiments of the invention;

FIG. 17 illustrate a series (1-5) of perspective views of large core assemblies that employ embodiments of the invention; and

FIG. 18 illustrates a high power inductor design, and provides comparative data listing key parameters of an inductor that employs a conventional stack of toroid cores versus an embodiment of the invention.

### DETAILED DESCRIPTION OF EMBODIMENTS OF THE INVENTION

Other than in the operating examples, or unless otherwise expressly specified, all of the numerical ranges, amounts, values and percentages, such as those denoting amounts of materials, times and temperatures of reaction, ratios of amounts, and others in the following portion of the specification, may be read as if prefaced by the word “about,” even though the term “about” may not expressly appear with the value, amount or range. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Notwithstanding the fact that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is identified herein is incorporated by reference herein in its entirety, but is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein, the terms “registration” or “interlocking engagement” refer to the association between a first and second magnetic core assembly segment, wherein at least a portion of the first segment comprises a first member, such as, for example, a protrusion, complementary to a second member, such as, for example, an indention, of the second segment, such that when the first segment engages the second segment to form an interlocking portion, motion of the first segment relative to the second segment is at least partially constrained when a force is applied. The terms “interlocking portion” or “interlocking interface” refer to the contact region wherein adjacent interlocking members, such as a protrusion and corresponding indentation, are joined. As used herein, the term “protrusion” refers to the portion of a segment that projects beyond what would otherwise be a flat or blunt surface of the segment. The term “indentation” refers to the portion of the segment that is recessed from what would otherwise be a flat or blunt surface of the segment. The term “unstacked,” as used herein, refers to single-tiered or single-layered magnetic core assemblies, in contrast to “stacked” assemblies having portions of the assembly that overlap or overlay other portions to form regions that are multi-tiered or multi-layered.

There exists a need in the current state of the art for fabrication techniques, using both existing and future materials that have desirable properties when produced from pre-cursor powders, that permit creation of larger components than are currently commercially available, and to do so in a manner that produces improved and uniform electromagnetic properties in a cost-effective manner.

In this regard, the invention is directed to electromagnetic cores assemblies, core segments for those assemblies, and their methods of manufacture. The assemblies may be, for example, inductor and transformer cores made for high power applications. Such assemblies can be held together by physically restraining the segments relative to one another by using straps, bands, clamps, pre-forms, molds and other physical devices; or by bonding segments together using a compatible adhesive, paint or other conformal coating. As discussed in detail herein, surfaces, such as the proximal surfaces, and some embodiments ends, of the abutting segments may be formed or contoured to provide interlocking engagement therebetween that corresponds to substantially accurate meshing or mating of the segments while substantially eliminating potential variability in inductance caused by inconsistent glue line thickness.

By way of introduction, the invention provides a soft magnetic core segment comprising a first interlocking member configured to form an interlocking portion with a second interlocking member of a second magnetic core segment. In another embodiment, the invention provides a magnetic core assembly comprising a first segment and a second segment, at least a portion of the first segment configured to form an interlocking portion with at least a portion of the second segment. The invention also provides stacked magnetic core assemblies comprising at least one segmented magnetic core assembly as described herein.

In general terms, the segments may be formed into the desired shape by compacting soft magnetic powders at pressures ranging up to 150 tons per square inch into shapes being selected from a family of geometries that all possess commonality in terms of providing mechanical registration of the segments with respect to one another in an assembly. The registration may be uniform, predictable, repeatable and unaffected by operator methodology during assembly of the segments. The resultant assemblies provide sufficient strength to withstand the rigors of being wound with heavy conductors when used as high power components in power supplies, power factor correction circuits, and other circuitry where large magnetic cores are advantageous.

In general terms, methods of forming the magnetic core segments of the invention include forming the magnetic core segment comprising an interlocking member, the interlocking member configured to form an interlocking portion with a second interlocking member of a second magnetic core segment. In another embodiment, the invention provides a method of forming a segmented magnetic core, comprising: contacting a first segment to a second segment, the first segment having an interlocking member configured to form an interlocking portion with a second interlocking member of the second magnetic core segment; and interlocking the first segment to the second segment to form the segmented magnetic core. Embodiments of the invention also provide methods of forming a stacked magnetic core assembly, comprising placing a first magnetic core assembly over a second magnetic core assembly, the first and second magnetic core assemblies each comprising an inter-layer interlocking member configured to form an inter-layer interlocking portion therebetween.

The segments of the invention may be made from any suitable soft magnetic materials known to those of ordinary skill in the art for compaction and sintering to develop desired magnetic properties. Suitable examples include ferrite powders, such as Ni—Zn or Mn—Zn ferrite powders, and combinations thereof. It is also contemplated that the segments may be made from a variety of insulated soft magnetic metal alloy powders, the powders being formed into a desired shape and further processed to enhance magnetic properties. Examples of suitable metal alloy powders include, for example, Fe, Fe—Al—Si, Fe—Co, Fe—Co—V, Fe—Mn, Fe—P, Fe—Si, Ni—Fe, Ni—Fe—Mo, and combinations thereof, as well as amorphous and nanocrystalline alloys of various well known chemistries. Accordingly, one of ordinary skill in the art will recognize that the segments and assemblies of the embodiments set forth herein may be formed of any soft magnetic materials that can be compacted from powders that exhibit useful properties in a wide range of electromagnetic circuits. Accordingly, embodiments of the invention may employ a wide variety of commercially available soft magnetic materials, such as those made from insulated metal alloy powders, as well as pressed and sintered ceramic soft magnetic materials, such as ferrites, and combinations thereof, and should not be construed as being limited to the type of materials employed.

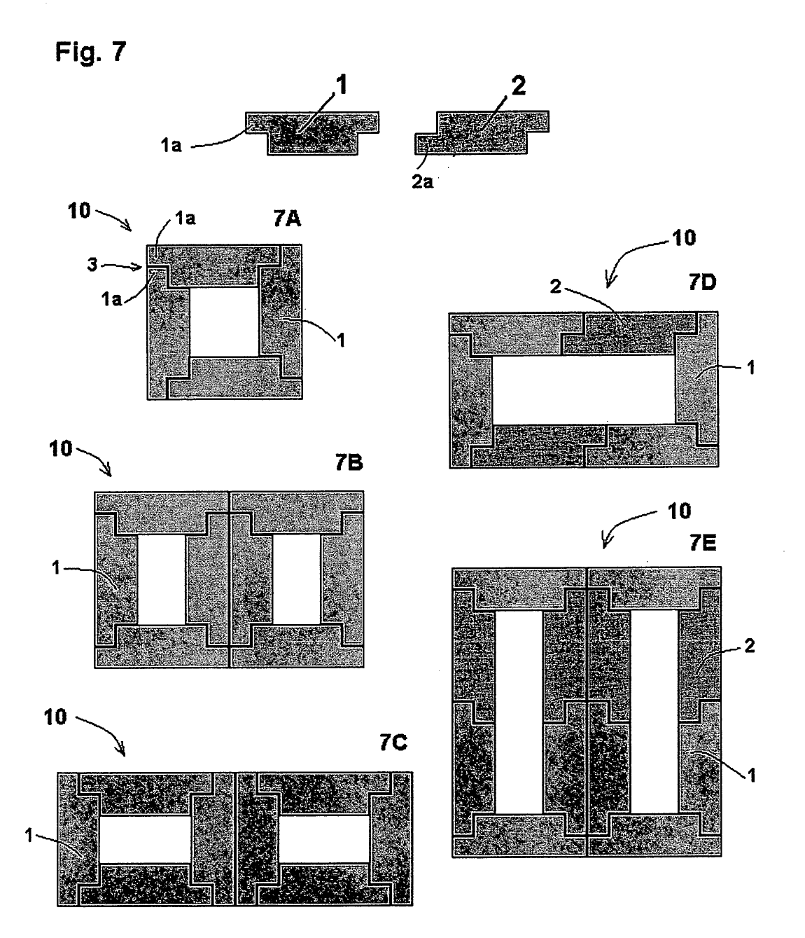

Referring to FIG. 7, several plan views of embodiments of the invention are illustrated, wherein segment 1 comprising interlocking portion 1a may be used in a variety of orientations or patterns in interlocking engagement to form magnetic core assemblies 10, such as those illustrated in FIGS. 7A, 7B, and 7C. By also using a complementary or mating second segment 2 comprising interlocking portion 2a, additional assemblies, such as those illustrated in FIGS. 7D and 7E, can be formed. The segments 1, 2 may be any suitable cross sectional configuration, such as, for example, square or rectangular, or any shape that lends itself to easily maintaining substantially complete surface-to-surface contact at the intersections of segments. As illustrated in FIGS. 7A-7C, each adjacent segment 1 may comprise a first interlocking member 1a configured to form an interlocking portion 3, identified as the contact region wherein a adjacent segments, such as segment 1, having interlocking members, such as interlocking member 1a, are joined. Interlocking members la may comprise a protrusion and/or a corresponding indentation, as illustrated, such that when adjacent segments 1 are joined, the protrusion and indentation form the interlocking portion 3. Although only one protrusion and one corresponding indentation are illustrated, it is contemplated that any number of protrusions and indentations may be employed in any configuration or pattern (e.g. linear, diagonal, diamond-shaped, and the like) to form the interlocking portion 3.

The interlocking members 1a, 2a may have any cross sectional configuration to promote for efficient meshing between an adjacent segment. For example, and as discussed below, the protrusion and the indentation may each have a matching or mating cross-sectional configuration, such as, for example, a stepped-pyramidal, a square, a rectangular, a trapezoidal, triangular or conical, or arcuate cross section, and the like, or any combination thereof can be used. One of ordinary skill in the art will recognize that additional interlocking configurations other than those illustrated herein may also be employed. In addition, one of ordinary skill in the art will recognize that other assembly configurations other than those illustrated may be employed.

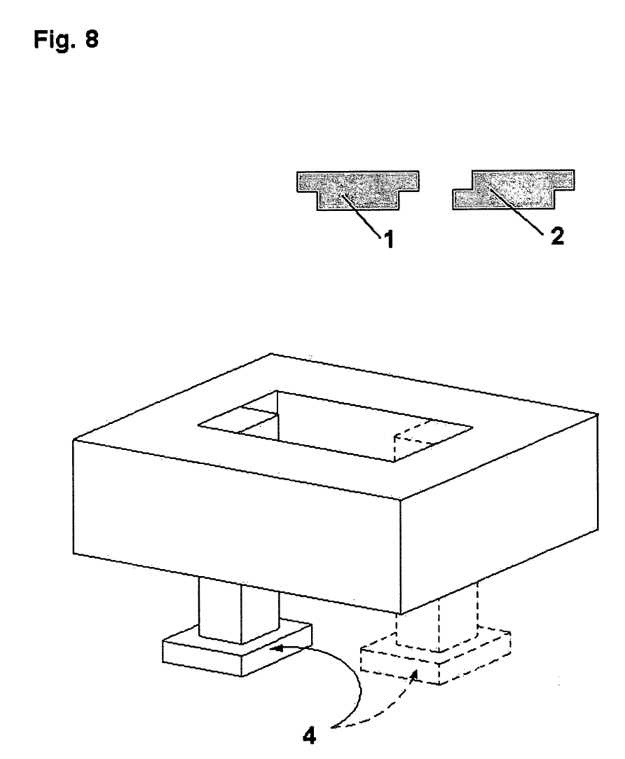

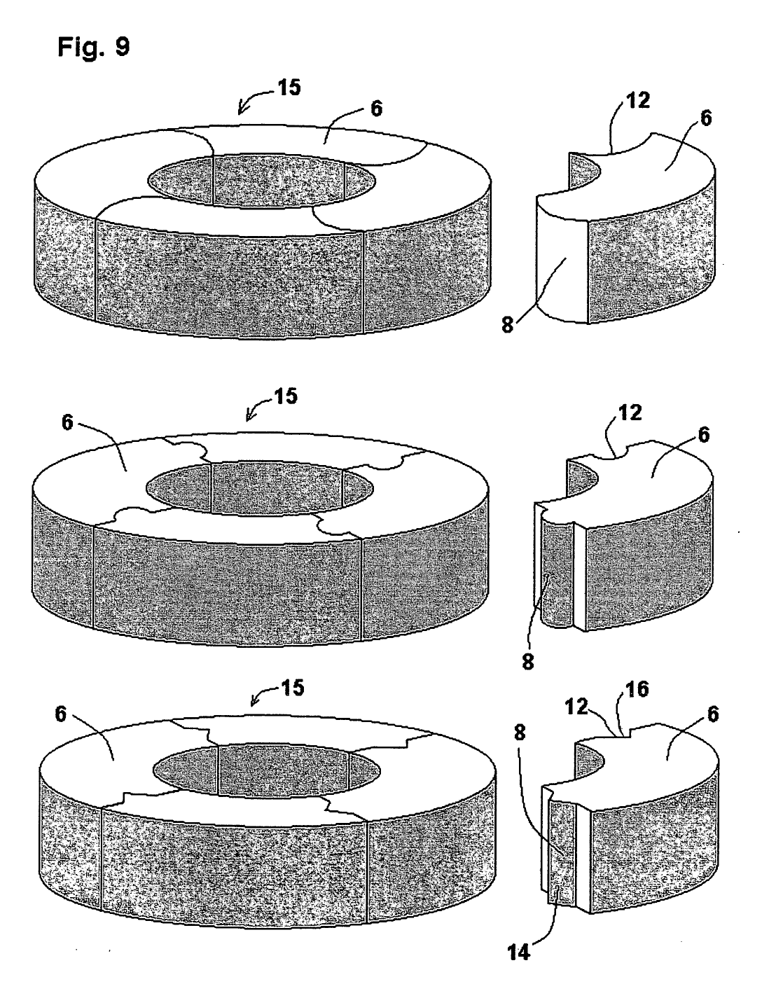

In addition, embodiments of the invention that employ the configuration set forth in FIGS. 7A-7E allow both segment shapes to be pressed using a single compacting die by repositioning some tooling components. This commonality reduces the overall cost of the powder compaction dies. This arrangement offers the additional benefit of reducing tooling costs by allowing one tool to press segments that can form a multitude of assembled shapes. FIG. 8 illustrates this tool design concept. By relocating the die inserts, 4, and by using one or more of these inserts 4, several usable shapes, such as segments 1, 2 may be formed. For clarity, the top and bottom punches are not shown in FIG. 8. In like manner, segments having more complex profiles, such as those illustrated in FIGS. 9, 11, 12A, 12B, 15A, and 15B, discussed hereinbelow, may be formed using dies and inserts having appropriate configurations, as will be appreciated by one of ordinary skill in the art. These more complex profiles may require dies with independently-controlled and adjustable punches, as well as presses that incorporate a more sophisticated series of movements that can be properly timed to create compacted cores with the proper shape and density. Manufacturers of these advanced press types include Dorst America, Inc, Bethlehem Pa., Osterwalder Inc., Cincinnati, Ohio, Gasbarre Products, Inc., DuBois, Pa., and the like.

It is contemplated that segments of the invention, such as those of FIGS. 7A-7E, may be made in a range of sizes, or any number of pieces-per-assembly. From an economic and practical standpoint, one of ordinary skill in the art will recognize that large assemblies can be made from two or more segments. Assemblies composed of a numerous segments may pose alignment and boding difficulties, but for various reasons may be desirable. In certain non-limiting embodiments, for example, it may be desirable to limit the number of segments to about 6, however, in certain embodiments using intricate or extremely large assemblies, higher numbers of segments may be desirable.

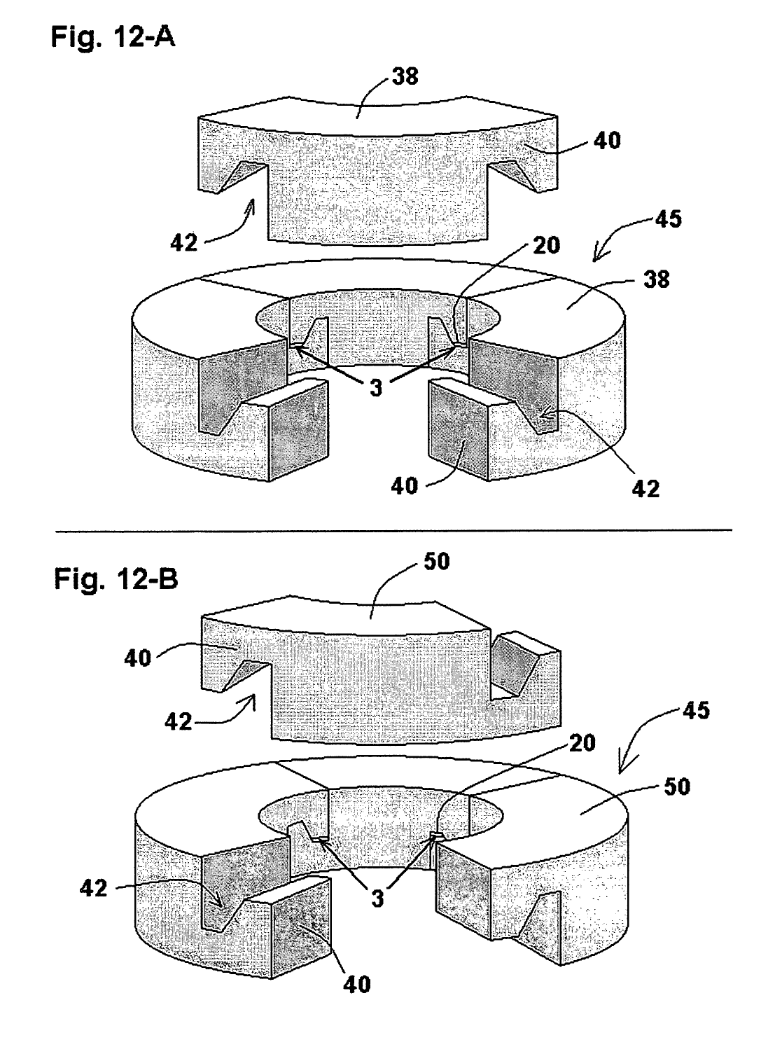

FIG. 9 illustrates embodiments of the invention directed to curved segments 6, and illustrates several methods of achieving registration and a degree of interlocking of the segments 6 to form completed assembly 15. In certain embodiments of the invention and as illustrated, a ring core, or toroid, assembly may be made from two or more separate segments 6, such as, for example, four separate segments, as illustrated. Assemblies with as few as two segments are contemplated. The number of segments per assembly may be at least two, with a maximum that is essentially unlimited. Various considerations, such as practical and economic factors for assembly, may affect the number of segments chosen for certain embodiments of the invention. As illustrated, each segment 6 may have, for example, at least one protrusion, such as convex protrusion 8, and at least one indention, such as concave indention 12 that may extend a portion or across the entirety of the segment end, as illustrated, that are designed to provide interlocking engagement between adjoining segments 6 and mesh accurately. Various other configurations, such as, for example, a V-shaped or triangular ridge or protrusion 14 and notch 16 orientation, as illustrated, may also be employed. It is also contemplated that in certain embodiments of the invention, assemblies 15 may have segments with both ends having either a convex or concave cross sectional configuration (i.e. a matching convex or concave cross sectional portion on either end), with an even number of segments being employed to create completed assemblies. Although the formation costs associated with embodiments having this configuration may be higher, due to extra tooling to press the segments, it is contemplated that certain applications could benefit from this configuration to facilitate final assembly of the segments. One such example of this latter embodiment is illustrated in FIG. 12A, discussed hereinbelow.

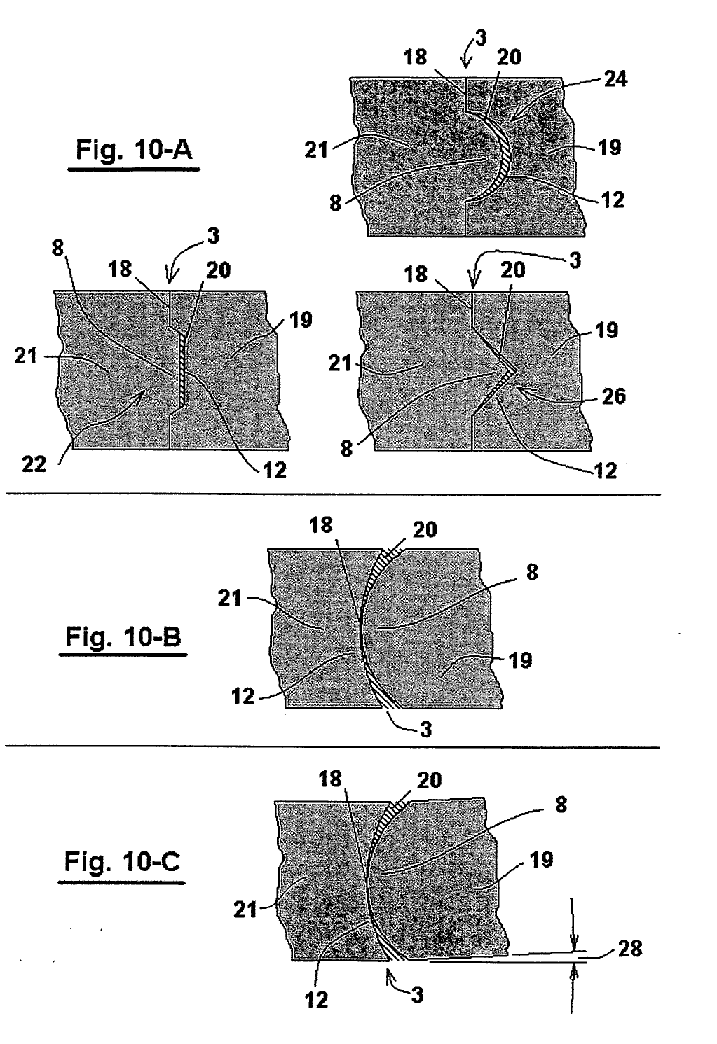

FIGS. 10A, 10B, and 10C illustrate additional embodiments of the invention comprising interlocking portions 3 having various profiles that may be engineered to provide segment-to-segment contact along portions of the interfaces 18. The segments may be restrained in a desired or selected shape and size by various mechanisms, such as, for example, by a peripheral restraint, such as, for example, by a band, a strap, a tape, or a clamp. In other embodiments, the interlocking portion 3 may be configured to include at least one gap portion 20 to receive a bonding material for attachment, such as an adhesive. The combination of a peripheral restraint and a bonding adhesive may also be employed. Various bonding materials known to those of ordinary skill in the art may be employed. Examples of bonding materials include one or two-part epoxies, polyurethanes, polyesters, polyimides, silicones, cyanoacrylates, acrylics, ceramics, curable rubbers, solders, hot melt glues, light-cured adhesives, low melting point glasses, and the like, and combinations thereof. The gap portion 20 may be, for example, an internal cavities, as shown in FIG. 10A, or open-ended gaps as shown in FIG. 10B, and may be purposefully created to leave room for adhesive even when the segments 19, 21 are in contact with one another. In certain embodiments, the volume of cured adhesive may be no more than the interstitial volume between segments 19, 21. As illustrated, cross sectional profiles of the protrusion 8 and the indention 12 may include, for example, a stepped pyramid 22, a concave/convex orientation 24 (either over a portion of the surface, as shown in FIG. 10A, or over substantially the entirety of the surface, as shown in FIG. 10B), and a triangular orientation 26. The use of profiles as shown in FIG. 10B, where contact between segments occurs in substantially the center portion of the protrusion and indention, or in substantially the center of the segment width allows any small amount of distortion or misalignment 28 to be accommodated while still providing segment-to-segment contact as shown in FIG. 10C. As discussed above, although only one protrusion and one corresponding indentation are illustrated, it is contemplated that any number of protrusions and indentations, may be employed to form the interlocking portion 3. For example, multiple protrusion and indentation arrangements include, for example, a sinusoidal or a saw-tooth arrangement. Other configurations will be well know to those of ordinary skill in the art reading the present disclosure.

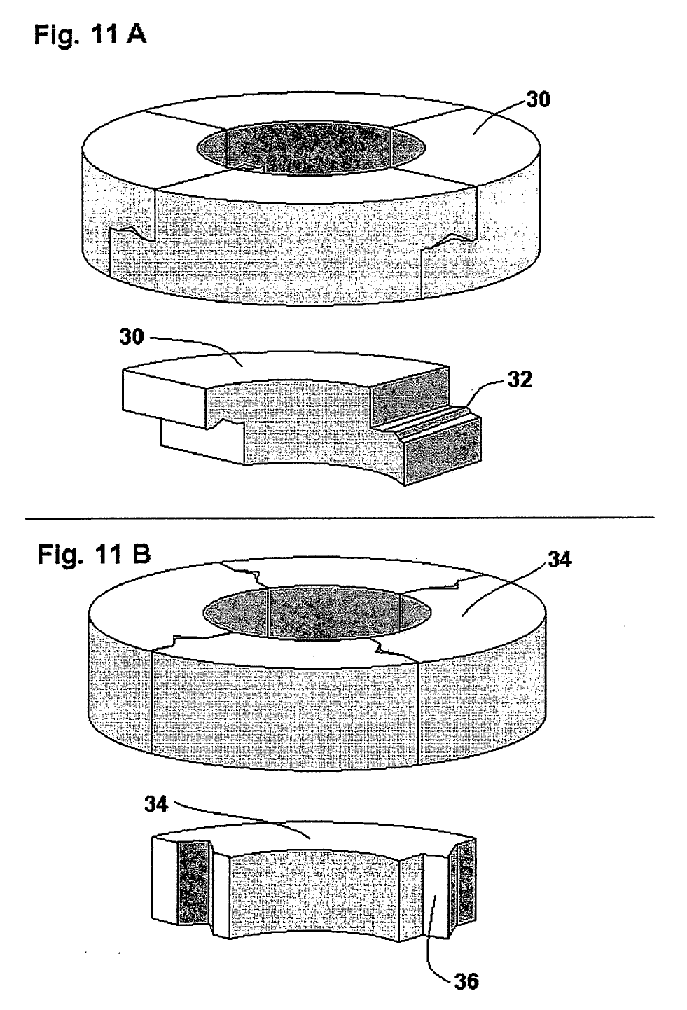

FIGS. 11A and 11B illustrate embodiments of the invention wherein the interlocking features on the distal ends of the segments 30, 34 may have either a radial orientation 32 or a circumferential orientation 36. Although various reasons may be present to employ either interlocking engagement 32, 36, those segments with horizontally-oriented profiles 32 may find applicability where a stronger adhesive bond may be required. In addition, those of ordinary skill in the art will recognize that a combination of radial 32 and circumferential 36 interlocking engagements may be employed.

FIGS. 12A and 12B illustrate additional non-limiting embodiments of the invention, and show other variations on the interlocking engagement at the interlocking portion 3 between segments 38, 50, respectively, with these embodiments offering the advantage of registering the segments 38, 50 more securely in the circumferential direction and making relatively effective and efficient engagement between the segments 38, 50 that form assembly 45. In this embodiment, and as illustrated, the first segment 38 may comprise at least one ridge portion 40 and at least one notch portion 42, and the second adjacent segment may comprise at least one corresponding ridge portion 40 and at least one notch portion 42 to form a key-type locking engagement. As described above, this design also permits inclusion of an interstitial gap portion 20, for retention of a glue line without also creating variation in the spacing between segments 38, 50. The volume of the interstitial gap can be calculated and the proper amount of adhesive can be metered onto one or both faces of the interlocking portions prior to assembly. By controlling the location and amount of adhesive precisely, one can avoid “squeeze-out” or overflow as the segments are brought into full contact. Such adhesive dispensers are commercially available, one example being the dispensers offered by EFD Dispensing Systems, Inc., East Providence, R.I. FIG. 12A illustrates the interlocking features with similar orientation, described above, and is an embodiment that requires an even number of segments in order to form a completed assembly 45. FIG. 12B illustrates interlocking features in opposition, allowing for either an even or odd number of segments 50 per assembly 45.

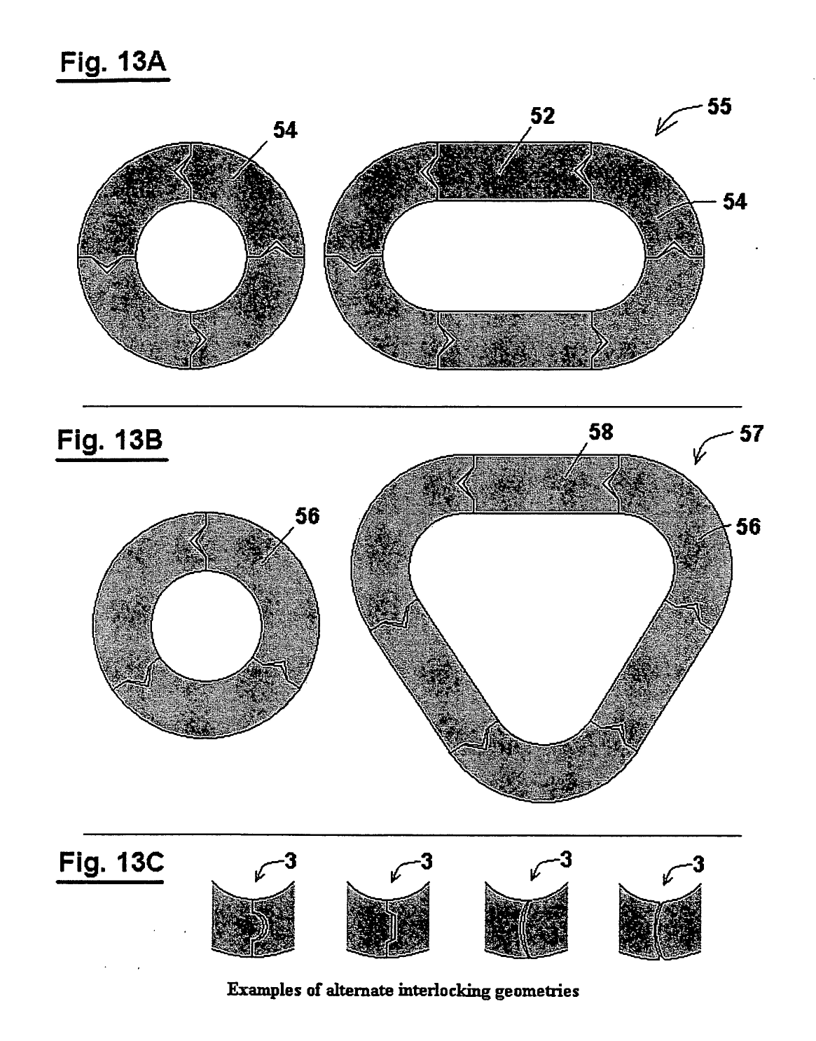

FIGS. 13-13C illustrate additional non-limiting embodiments of the invention and provide assemblies 55 wherein a magnetic core combines substantially straight segments 52 and arcuate or curved segments 54, and may employ registered and interlocked ends, as discussed hereinabove. For example, FIG. 13A illustrates assembly of a toroid from four substantially equal curved segments 54. By introducing two straight segments 52, positioned as illustrated, an oval toroid assembly 55 may be assembled. In another embodiment, FIG. 13B illustrates a toroid assembled from three substantially equal arc or curved segments 56. By interspersing or alternating straight segments 58 between each curved segment 56, a triangular-shaped toroid assembly 57 may be formed. Other configurations such as a round-cornered square or a round cornered rectangle may also be formed. As discussed above, and as further illustrated in FIG. 13C, interlocking ends of the segments can employ various interlocking portions 3 that vary in profile while still providing the advantages taught in this invention.

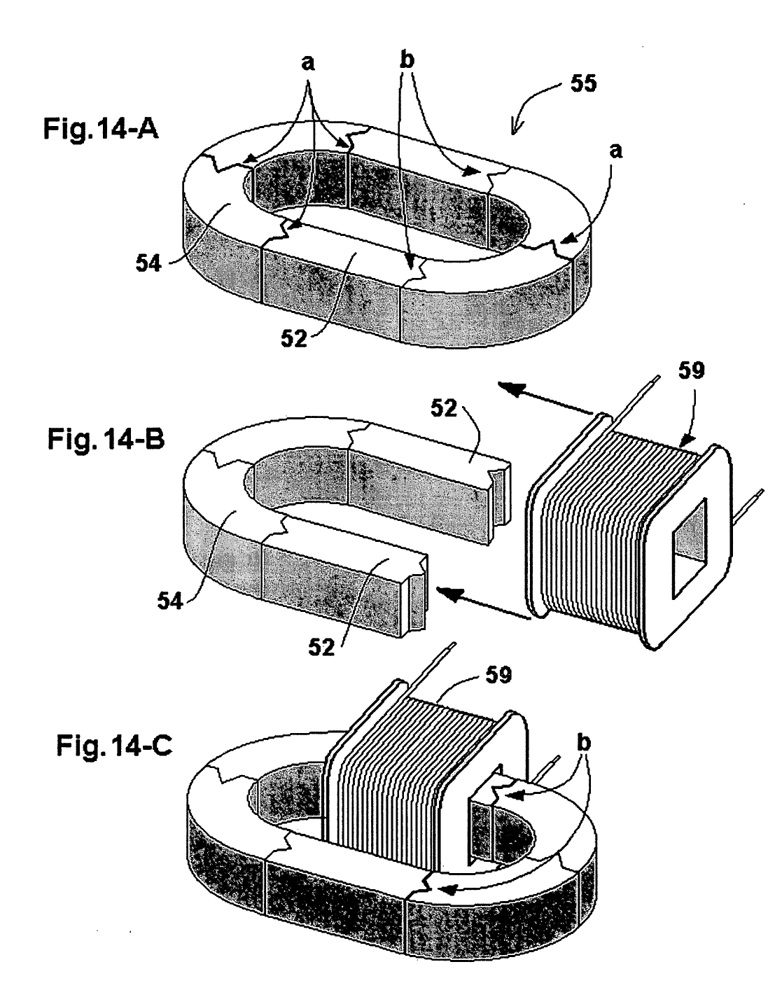

FIG. 14 illustrates a non-limiting assembly procedure employing an oval-shaped toroid 55 (as illustrated in FIG. 13A) and a wire coil 59 that illustrates certain advantages that may be obtained by the invention. As discussed above, the toroid 55 may be partially assembled employing straight segments 52 and curved segments 54. A bonding material, such as glue, may be applied to interlocking interfaces a in the area of the interstitial gap, as shown in FIG. 14A to at least partially restrain the partially completed assembly. In this embodiment, glue is not applied to interfaces b at this stage. All segments 52, 54 of the assembly 55 may be held in position and at least partially restrained during the cure of the adhesive to provide proper alignment. Suitable restraining members include peripheral restraints, such as a band, a strap, a tape, or a clamp. The cured segments may then be separated at interface b, and the wire coil 59 may be placed over one of the open ends, as shown in FIG. 14B. The wire coil 59 may be, for example, a pre-wound bobbin, as illustrated, or a self-supporting wire coil pre-form. The balance or remainder of the segments may be re-positioned to complete the core assembly 55 and adhesive may be applied to interface b and cured, as shown in FIG. 14C, to form the final assembly. Optionally, all segments 52, 54 may be glued at once after the wire coil 59 is inserted onto the core.

As can be recognized by one of ordinary skill in the art, embodiments of the invention, such as those discussed herein, allow pre-formed coils of wire, such as a pre-wound bobbin, to be inserted onto the semi-assembled segments prior to completed assembly, and thereby reduce the costs normally associated with winding toroids. This is in contrast to conventional toroids, where wire must be wound directly onto the core using specialized winding equipment such as that manufactured by Gorman Machine Corp., Brockton, Mass., or Jovil Manufacturing Co., Danbury, Conn. Circuit designers most often choose toroid cores for inductor applications, however one drawback of using them is the extra cost associated with applying the winding. A toroid winding machine requires pre-winding the proper length of wire onto a spool before it is transferred to the core, making it slower than the bobbin winding process used with mated cores such as E-E, E-I, U-U, U-I, C-C and C-I configurations. Embodiments of the invention that employ segmented assemblies allow pre-wound wire to be placed over various segments without the need for special winding processes.

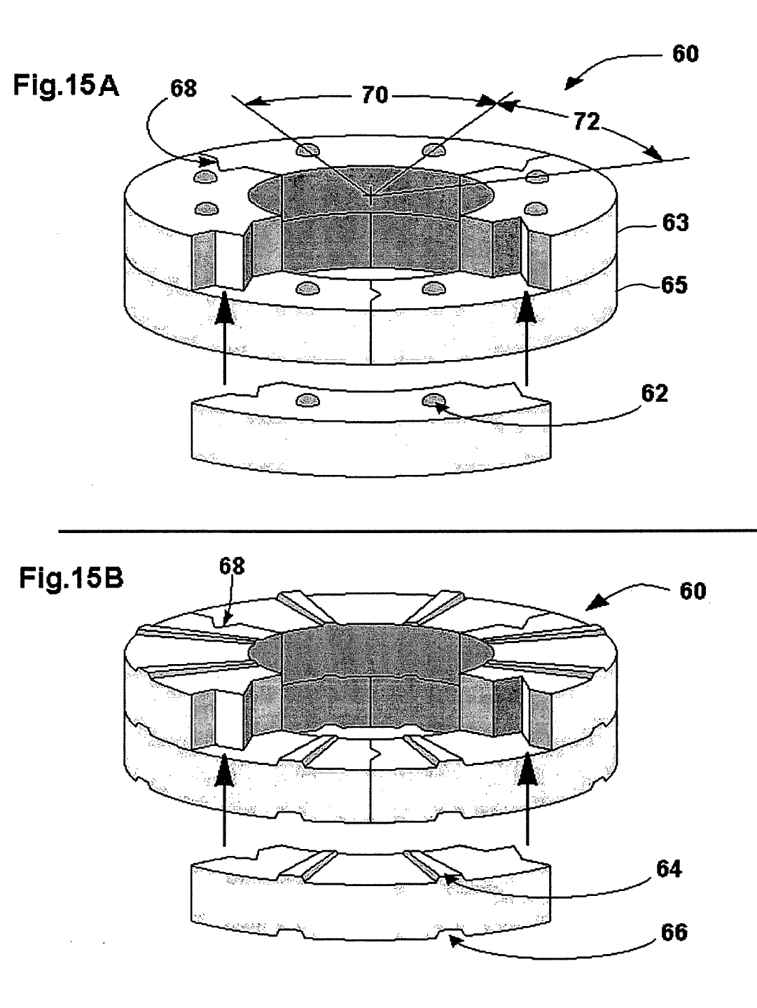

FIGS. 15A and 15B illustrate additional embodiments of the invention wherein both intra-layer and inter-layer (i.e. stacked) registration of the segments may be formed, and wherein a stacked magnetic core assembly 60, comprising first core assembly 63 and second magnetic core assembly 65 each comprise an inter-layer interlocking member 62, 64 configured to form an interlocking portion therebetween. In this embodiment, although ring cores 63, 65 formed from curved segments are illustrated, it is contemplated that any suitably shaped electromagnetic assembly or magnetic core may be employed. In addition, the stacked magnetic core assembly 60 may have segmented cores, as illustrated and described herein, solid, unsegmented cores, or a combination of both segmented an unsegmented cores. Embodiments that employ segmented cores can be used to enlarge the final core assembly even further should the application require it. Careful design and placement of registration profiles make alignment between layers easy to achieve and does so in a repeatable and consistent manner. As illustrated, these profiles may be concave and convex shapes that nest together when stacked.

As shown in FIG. 15A, one or more convex protrusions, illustrated as raised hemispherical curvatures 62, may be pressed onto individual segments that form the magnetic core 65 (or on one face of an unsegmented magnetic core (not shown)) during formation. Mating concave protrusions, such as recessed hemispherical curvatures (not shown), may be pressed onto individual segments that form the adjacent magnetic core 63 (or on the opposite face of an unsegmented magnetic core (not shown)) such that the concave protrusions are, for example, aligned directly under the convex protrusions 62 to form an interlocking portion when interlocking engagement between magnetic cores 63, 65 is desired. It is also contemplated that in some embodiments it may be desirable to press a combination of concave and convex protrusions into one face of a magnetic core and a combination of concave and convex protrusions in an opposing face. Also, as illustrated, when embodiments of the invention employ more than two stacked magnetic cores, both faces of the magnetic cores may have protrusions or indentations, or some combination of both, for receipt of magnetic cores on each face thereof.

FIG. 15B illustrates a second embodiment whereby the protrusions and indentation profiles are illustrated as convex grooves 64 and concave grooves 66, respectively, with, for example, a trapezoidal cross section. The grooves 64, 66 may be positioned in any manner that provides suitable interlocking engagement, such as being formed in a radial orientation, as illustrated. Meshing and registration of segments within a layer is accomplished with the use of various profiles 68, described in detail herein, and illustrated in FIGS. 9-13.

In certain embodiments of the invention, careful placement of the profiles along the top and bottom faces of the segments allow spacing between profiles within each segment 70 that may be equal to the spacing between profiles on adjacent segments 72 that allow the layers to be stacked either directly on top of one another or to overlap those of the layer above and beneath, as illustrated. By overlapping segments in this way, additional strength of the assembly can be achieved by the inherently greater interfacial surface on which to apply adhesive. Any variation in glue line thickness in this plane will not affect permeability or other properties of the assembly. This is because the magnetic flux created in the wound and energized core is parallel to the circumference of the assembly. Magnetic flux is not impeded by air gaps that are parallel to it. The stacked segmented magnetic core assembly 60 allows a wire coil, such as a pre-wound bobbin (not shown) to be placed over at least one of a first segment of the magnetic core 65 and a second segment of the magnetic core 63.

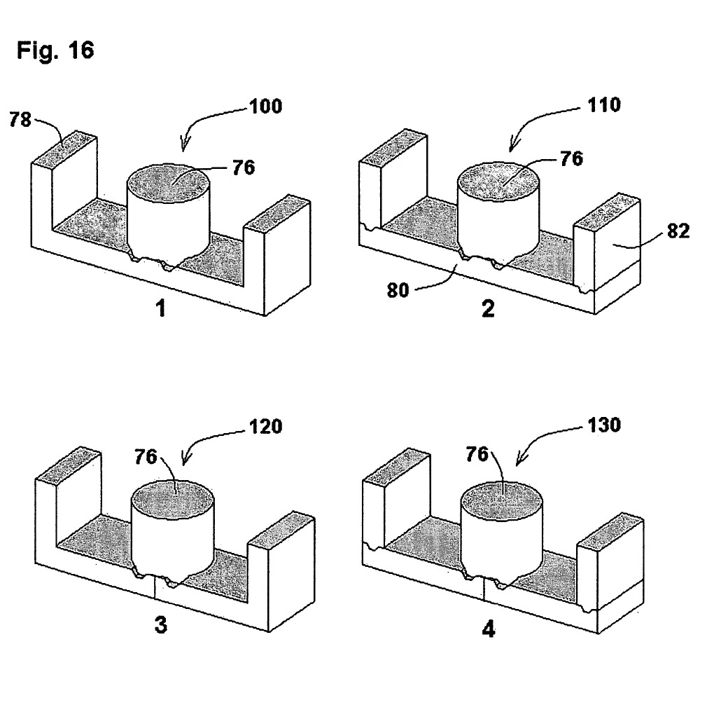

FIG. 16 illustrates an additional embodiments of the invention that combine segments with different cross sectional geometries, and demonstrates the flexibility of the invention to produce a wide variety of complex core assemblies. The general configuration of the assembly in this figure is an E-core with a round center leg 76. The invention can be applied to this shape as shown in the four examples in FIG. 16. As illustrated multiple interlocking portions are employed in Example 1-4. Example 1 illustrates a 2-segment assembly 100. In this embodiment the U-shape portion 78 that creates the base and two outer legs may be pressed as a single piece separate from the round center leg 76. Interlocking profiles as described above may be pressed into each segment 76, 78, to form the two-piece assembly 100. Example 2 illustrates a 4-piece assembly 110 wherein the base 80 may be separate from each of the outer legs 82 and center leg 76. By separating the U-shape from Example 1 into 3 distinct pieces, each piece would require less pressing force due to its smaller pressing area. Conversely, if the same pressing force is used, then each of the pieces in Example 2 could be larger, and the resulting assembly 110 would be larger. Examples 3 and 4 illustrate the same progression as Examples 1 and 2, respectively, with a modified base assembly made in two pieces rather than one. Embodiments 120, 130 illustrated in Examples 3 and 4 may extend the size range of the final assembled cores even further than either Examples 1 or 2. Indeed, this approach exemplifies the means by which a series of core assemblies 100, 110, 120, and 130, all from the same general geometric family, can be produced using concepts described in the present disclosure. The various interlocking profiles as described and illustrated in FIGS. 7, 10, 13, and 14, as well as other profiles that may now be readily contemplated by one of ordinary skill in the art, may be employed with the embodiments illustrated in FIG. 16.

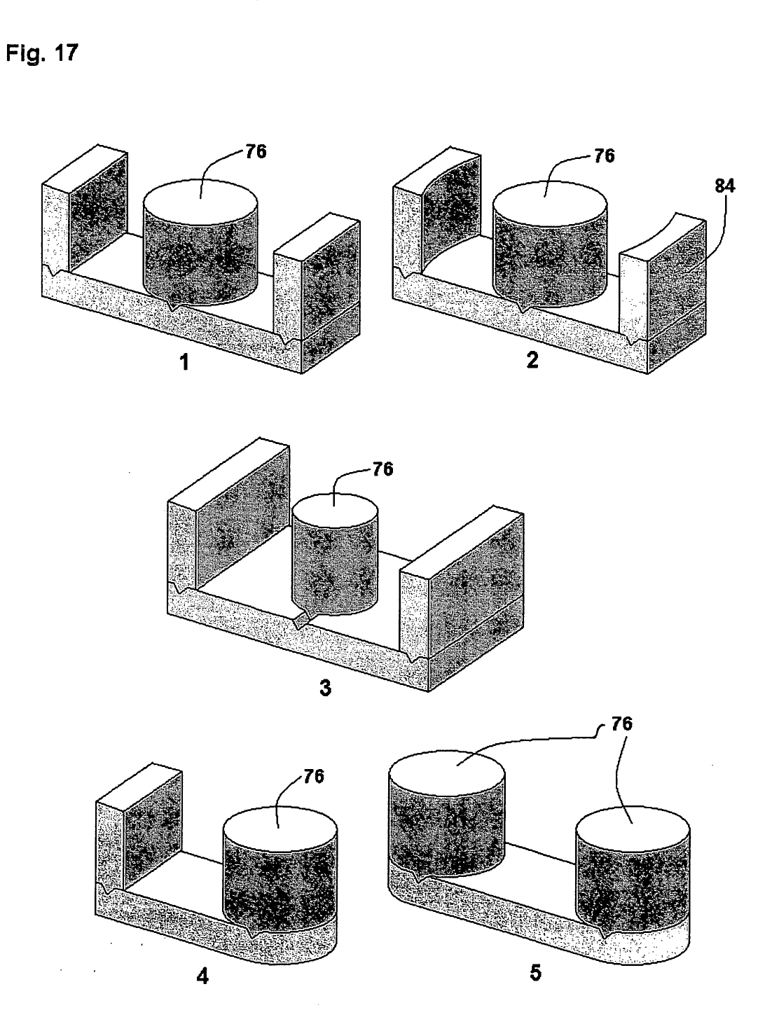

FIG. 17 illustrates additional embodiments of the invention employing a round leg 76. Using a round leg 76, such as a center leg as illustrated in Embodiments 1, 2, and 3, instead of a square or rectangular one, is often preferred in high-power applications. To those skilled in the art of constructing transformers and inductors where high power is applied, it is well known that the overall efficiency of the wound and assembled unit is affected by the hysteresis, eddy current and residual losses associated with the magnetic material, as well as the resistive losses of the copper windings. Resistance of any conductor increases as its length increases. By using a round leg 76, each turn of wire is shorter than that would around a square or rectangular leg of the same cross section, thus reducing the winding resistance and improving overall efficiency of the component. Example 1 provides a configuration similar to the embodiment illustrated in Example 2 of FIG. 16, but with a slightly varied interlocking profile (a single V-shaped triangular profile instead of two stepped pyramid profiles) of the segments. Example 2 provides a configuration similar to Example 1, but with curved outer legs 84. Example 3 illustrates a center leg 76 that is smaller in diameter than the width of the outer legs. This example illustrates additional design flexibility in assembling segments. Example 3 provides additional electromagnetic shielding of the wire coil, which aids in reducing fringing flux and stray electromagnetic interference. Examples 4 and 5 illustrate round legs 76 that are positioned on an outside portion of the assembly, either in combination with a flat leg, as shown in Example 4, or in combination with a second round leg 76, as shown in Example 5 to create U-shaped core assemblies. Examples 4 and 5 illustrate embodiments of the invention that can be applied to other common core configurations currently available in smaller, single-piece shapes from a variety of manufacturers.

The segments of embodiments of the invention may form assemblies that may be useful in a wide range of applications and configurations that employ large, economical cores such as, for example, in switching power supplies, flyback transformers, power factor correction circuits, high power transformers and high power inductors such as inductors for inverters, inductors for solar energy power conversion, inductors for wind energy power conversion, inductors for fuel cell power conversion, inductors for transportation power conversion applications, such as train traction and electric/hybrid vehicles.

The invention will be further described by reference to the following example. The following example is merely illustrative of the invention and are not intended to be limiting.

### EXAMPLE

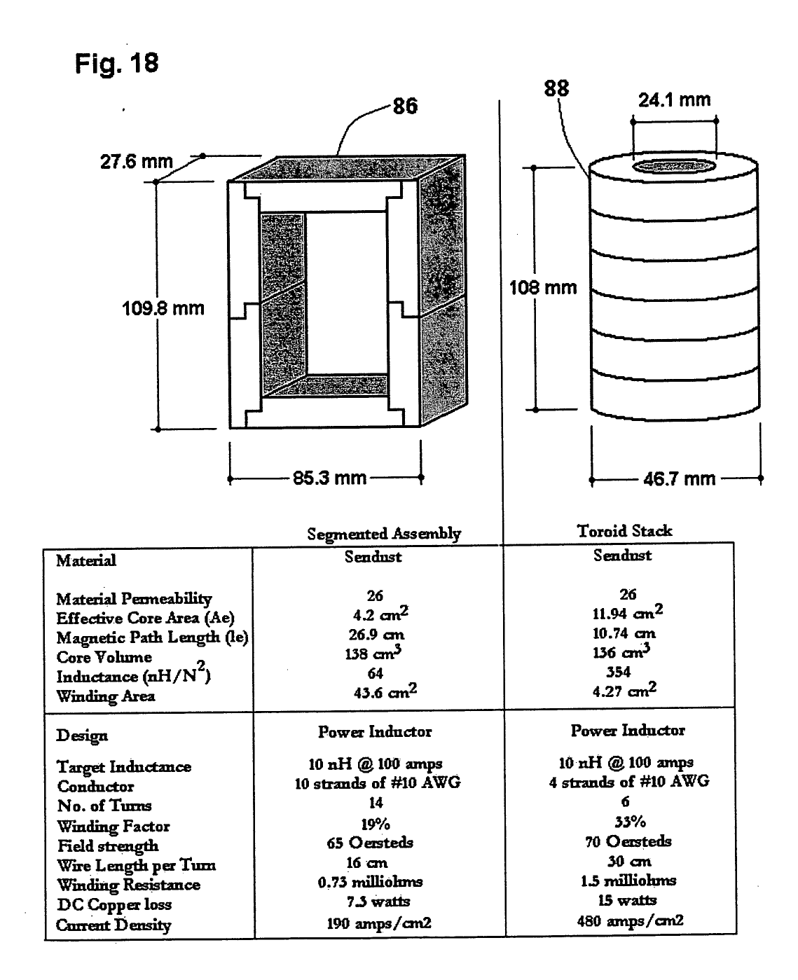

FIG. 18 compares a high power inductor design using a segmented core 86 of the invention with a conventional stack of commercially available toroid cores 88. The sample power inductor design compares a soft magnetic core assembled from segments as described herein with that made from a conventional core made from a stack of smaller toroids. The formulas used to calculate the values are well known to those skilled in the art of inductor design and are not shown in the figure. As illustrated in FIG. 18, significant differences in properties, such as the winding area, conductor size, DC copper loss and current density, are shown between the unitary magnetic core assembly of the invention versus the stacked magnetic core in the FIG. 18.

In the comparison both core assemblies are made from a 26-perm sendust (Fe—Al—Si) alloy. Both cores have essentially identical volumes of magnetic material (136 cm³, 138 cm³) and, therefore, the same energy storage capability when used as an inductor. The physical dimensions of the assemblies are used to calculate the effective core area (Aₑ), magnetic path length (Iₑ) and core volume (Vₑ) according to industry accepted standards published by the International Electrotechnical Commission, Geneva, Switzerland, publication IEC-205. Inserting these values into Equation 2, the inductance of each assembly is calculated and expressed in terms of nanohenries-per-turns-squared (nH/N²). Using each of these assemblies to create a 10 nH inductor at 100 amperes of current, the results are shown in the Table in FIG. 18. The comparison shows that both core geometries are capable of meeting the design requirement, but several factors make the segmented core assembly desirable over the stack of toroids. Referring to the Table in FIG. 18, the Winding Area of the toroid stack is more than 10 times smaller than the segmented assembly (4.27 cm² vs. 43.6 cm²), and the toroid geometry requires that the conductors be threaded through the hole for each turn. The toroid requires 6 turns of wire to achieve the target inductance of 10 nH, each turn comprised of 4 parallel strands of #10 AWG wire. This is a very heavy bundle of wire and care must be taken to avoid breaking the cores during winding, as well as carefully placing the wires through the hole so there is room for subsequent turns. The ratio of the cross section of the windings to the winding area of the core is known as the “winding factor,” and a typical winding factor is between 20% and 60%. When multiple strands of wire are wound together, the winding factor is closer to the lower end of this range since keeping the strands parallel and closely aligned is difficult. The winding factor for the stacked toroids in this example is 33% and will prove to be a tight fit. In contrast, embodiments of the invention require 14 turns of wire, each turn made of 10 strands of #10 AWG wire. This is a much heavier conductor, but the larger Winding Area results in a window fill that is half that of the toroid. The winding factor for this example is 19% and can be easily accomplished. In addition, the 14 turns of wire can be pre-wound onto a bobbin pre-form and slid over one of the segments during assembly. Using more strands of wire, the Current Density is much lower in the segmented core than in the toroid stack (190 amps/cm²vs. 480 amps/cm²). The Wire Length per Turn is shorter in the segmented core (16 cm vs. 30 cm) and therefore the DC Copper Loss is less than half of the toroid stack (7.3 watts vs. 15 watts). A primary concern of engineers is to minimize losses when designing circuitry. In the example shown in FIG. 18, the lower loss configuration is the segmented assembly with half the copper losses.

Embodiments of the invention set forth herein provide designs of magnetic core segments that provides accurate registration of each segment within an assembly. The registration can be both circumferential as well as inter-laminar. Because the interlocking members can take many profiles, the interlocking portion between the segments can be engineered to provide both interlocking engagement and at least one gap portion for receipt of a bonding material, such as an adhesive. The interlocking members provides the added benefit of restricting adhesive to certain areas of the abutting segment ends so as to provide the necessary strength of the final assembly. The interlocking portions can provide direct segment-to-segment contact in areas adjacent to the cavities so that the adhesive thickness does not affect the inductance of the final assembly. The assembly provides improved uniformity in inductance from assembly to assembly. The assembly can take many forms, including forms that combine different and individual segment cross sections together and form more complex assemblies. The individual interlocking segments may be selected based on a desired or selected size and shape of the assembly. Complex assemblies have the additional benefit of incorporating round cross section segments with rectilinear segments so as to reduce winding losses when the assembly is used in high power applications.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A method of forming a magnetic core segment, comprising:
forming a magnetic core segment comprising an interlocking member thereon, the interlocking member configured to form an interlocking portion with a second interlocking member of a second magnetic core segment.

2. The method of claim 1, further comprising forming the second magnetic core segment comprising the second interlocking member, wherein the interlocking member comprises a protrusion and the second interlocking member comprises an indentation.

3. The method of claim 2, further comprising forming the protrusion and the indentation to comprise a mating cross-sectional configuration selected from the group consisting of a square, a rectangle, a trapezoid, a triangle, and an arc.

4. The method of claim 2, further comprising forming the protrusion and the indentation to provide a segment-to-segment contact along portions of interfaces therebetween, wherein the interlocking portion comprises at least one gap portion to receive a bonding material.

5. The method of claim 2, further comprising forming the protrusion and the indentation in at least one of a radial and circumferential orientation.

6. The method of claim 1, further comprising forming the magnetic core segment to comprise two ends, at least a portion of each end having a cross-sectional configuration selected from the group consisting of a concave configuration and a convex configuration.

7. The method of claim 1, further comprising forming the interlocking member to comprise a ridge portion and a notch portion.

8. The method of claim 1, further comprising forming the magnetic core segment from a soft magnetic material selected from the group consisting of a ceramic material, a powdered metallic alloy, and combinations thereof.

9. The method of claim 8, wherein the ceramic material is selected from the group consisting of Mn—Zn ferrite, Ni—Zn ferrite, and combinations thereof.

10. The method of claim 8, wherein the powdered metallic alloy is selected from the group consisting of Fe, Fe—Al—Si, Fe—Co, Fe—Co—V, Fe—Mn, Fe—P, Fe—Si, Ni—Fe, Ni—Fe—Mo, and combinations thereof.

11. The method of claim 1, further comprising forming at least a portion of the magnetic core segment to have a cross section that is selected from the group consisting of a round, an oval, a square, a triangular, and a rectangular configuration.

12. The method of claim 1, further comprising forming at least a portion of the magnetic core segment to be curved.

13. A method of forming a segmented magnetic core assembly, comprising:
contacting a first segment to a second segment, the first segment having an interlocking member configured to form an interlocking portion with a second interlocking member of the second magnetic core segment; and
interlocking the first segment to the second segment to form the segmented magnetic core assembly.

14. The method of claim 13, wherein the interlocking member comprises at least one protrusion and the second interlocking member comprises at least one indentation, the protrusion and indentation being configured to form at least a portion of the interlocking portion.

15. The method of claim 14, wherein the at least one protrusion and the at least one indentation provide a segment-to-segment contact along portions of interfaces therebetween, the interlocking portion comprising at least one gap portion to receive a bonding material.

16. The method of claim 15, wherein the segment-to-segment contact occurs at substantially a center portion of the protrusion and the indentation.

17. The method of claim 13, wherein the first segment comprises two ends, at least a portion of each end having a concave configuration, and the second segment comprises two ends, at least a portion of each end having a convex configuration.

18. The method of claim 13, wherein at least one end of the first segment comprises a ridge portion, and at least one end of the second segment comprises a corresponding notch portion.

19. The method of claim 18, wherein at least one end of the first and the second segment each comprise a corresponding ridge and notch portion.

20. The method of claim 13, wherein the first and second segments are formed of a soft magnetic material selected from the group consisting of a ceramic material, a powdered metallic alloy, and combinations thereof.

21. The method of claim 13, wherein at least a portion the core has a cross section that is selected from the group consisting of a round, an oval, a square, a triangular, and a rectangular configuration.

22. The method of claim 13, wherein the first and the second segments are formed using a single compacting die.

23. The method of claim 13, wherein at least one of the first and the second segment is curved.

24. The method of claim 13, wherein the first segment is curved and the second segment is substantially straight.

25. The method of claim 24, wherein the magnetic core is selected from the group consisting of an oval toroid, a triangular toroid, a round-cornered square, and a round cornered rectangle.

26. The method of claim 13, further comprising placing a pre-formed wire coil over an end of at least one of the first and second segment prior to the interlocking.

27. The method of claim 26, wherein the wire coil is a pre-wound bobbin.

28. The method of claim 26, further comprising applying a bonding material to at least one gap portion between the interlocking member and the second interlocking member.

29. The method of claim 28, wherein applying the bonding material occurs following the placing of the wire coil.

30. A method of forming a stacked magnetic core assembly, comprising:
placing a first magnetic core assembly over a second magnetic core assembly, the first and second magnetic core assemblies each comprising an inter-layer interlocking member configured to form an inter-layer interlocking portion therebetween.

31. The method of claim 30, further comprising forming at least one of the first and second magnetic core assembly from at least two segments.

32. The method of claim 30, wherein the inter-layer interlocking portion is selected from the group consisting of a protrusion and an indentation.

33. The method of claim 30, wherein the first magnetic core assembly comprises at least one protrusion on a face portion thereof, and the second magnetic core assembly comprises at least one indentation on a face portion thereof, the protrusion and the indentation being configured to form the inter-layer interlocking portion.

34. The method of claim 31, further comprising forming each of the first and second magnetic core assemblies from at least two segments.

35. The method of claim 34, further comprising placing a pre-formed wire coil over at least one of a first segment of the first magnetic core and a second segment of the second magnetic core.

36. The method of claim 35, wherein the wire coil is a pre-wound bobbin.

37. A method of forming a segmented magnetic core assembly, comprising selecting individual interlocking segments based on a selected size and shape of the assembly.

38. The method of claim 37, wherein the segments each comprise at least one interlocking member, and wherein the segments are oriented to align the interlocking member of each segment to create an interlocking interface.

39. The method of claim 38, further comprising:
interlocking the segments to form a completed assembly; and
restraining the assembly to hold a selected shape.

40. The method of claim 39, wherein the restraining is at least partially performed by a peripheral restraint selected from the group consisting of a band, a strap, a tape, and a clamp.

41. The method of claim 39, wherein the restraining is at least partially performed by an adhesive applied to the interlocking interface.

42. The method of claim 41, wherein the adhesive is selected from the group consisting of one or two-part epoxies, a polyurethane, a polyester, a polyimide, a silicone, a cyanoacrylate, an acrylic, a ceramic, a curable rubber, a solder, a hot melt glue, a light-cured adhesive, a low melting point glass, and combinations thereof.

43. The method of claim 38, wherein the interlocking interface comprises an interstitial gap when segment-to-segment contact is created.

44. The method of claim 43, further comprising applying an adhesive to the interlocking interface in the area of the interstitial gap.

45. The method of claim 44, wherein the volume of cured adhesive is no more than the interstitial volume between segments.

46. The method of claim 38, further comprising aligning the segments such that a partially completed assembly is formed.

47. The method of claim 46 wherein selected portions of the assembly are assembled with an adhesive.

48. The method of claim 47, further comprising placing a member selected from the group consisting of a pre-wound coil of wire and a pre-wound bobbin of wire over the partially completed assembly.

49. The method of claim 48, further comprising:
completing the assembly with a balance of segments to form the final assembly; and
bonding the balance of segments with an adhesive.
